(19) United States
(12) Patent Application Publication
(10) Pub. No.: US 2014/0144280 A1
(43) Pub. Date: May 29, 2014

(54) RETRACTABLE HANDLE FOR MOBILITY SCOOTER

(71) Applicant: FREERIDER CORP., Kaohsiung City (TW)

(72) Inventor: MAO-CHIANG CHEN, KAOHSIUNG CITY (TW)

(73) Assignee: FREERIDER CORP., KAOHSIUNG CITY (TW)

(21) Appl. No.: 13/684,789

(22) Filed: Nov. 26, 2012

(51) Int. Cl. B62K 21/12

(52) U.S. Cl. CPC B62K 21/12
USPC 74/551.4

(57) ABSTRACT

A retractable handle includes a handle and at least one tubular member is movably mounted to the handle. A resilient member is located between the handle and the at least one tubular member. A positioning unit is connected to the handle and the tubular member so as to position the tubular members to the handle.

### BACKGROUND OF THE INVENTION

1. Fields of the invention

The present invention relates to a retractable handle, and more particularly, to a retractable handle of a mobility scooter.

2. Descriptions of Related Art

The conventional retractable handle of a mobility scooter is disclosed in Taiwan Patent Publication No. 1347279 and M261441, and the retractable handle still protrudes beyond two sides of the body of the scooter and is easily hit during transportation and storage.

The present invention intends to provide a retractable handle of a mobility scooter and the handle in retracted status is short and compact, while the handle is extended and secured when in use.

### SUMMARY OF THE INVENTION

The present invention relates to a retractable handle and comprises a handle and at least one tubular member is movably mounted to the handle. A resilient member is located between the handle and the at least one tubular member. A positioning unit is connected to the handle and the tubular member so as to position the tubular members to the handle.

The primary object of the present invention is to provide a retractable handle wherein the tubular member is moved relative to the handle and positioned at the extended position to increase the length of the handle.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is an exploded view to show the retractable handle of the present invention;

FIG. 2 is a cross sectional view of the retractable handle of the present invention;

FIG. 3 is a perspective view to show that the tubular member is pulled relative to the handle of the present invention, and

FIG. 4 is a perspective view to show that the tubular member is positioned relative to the handle of the present invention.

### DETAILED DESCRIPTION OF THE PREFERRED EMBODIMENT

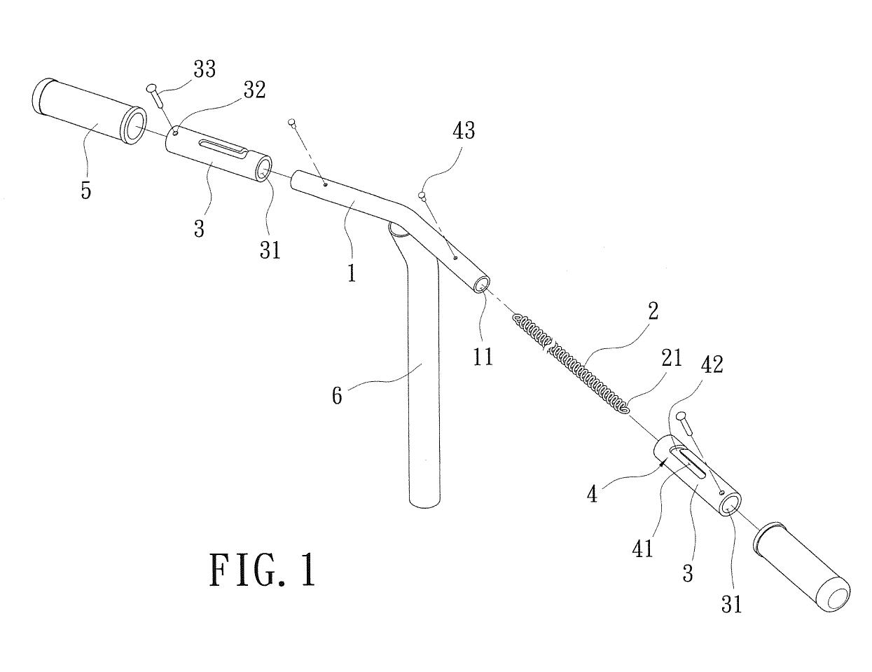

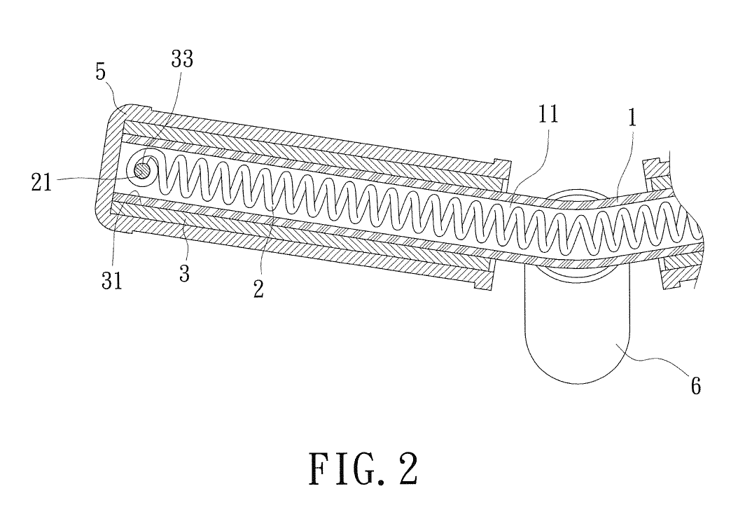

Referring to FIGS. 1 and 2, the retractable handle of a mobility scooter of the present invention comprises a handle 1, a resilient member 2, two tubular members 3, two positioning units 4 and two grasp tubes 5.

The handle 1 is connected to a steering post 6 of the mobility scooter and extends toward two opposite directions of the steering post 6. The handle 1 is a hollow tube.

The resilient member 2 is one of a spring, a rubber band and a compound resilient member. The resilient member 2 is located in a first space 11 of the handle 1.

The two tubular members 3 are respectively mounted to the two ends of the handle 1. The resilient member 2 is located in the second spaces 31 of the two tubular members 3. Each of the two tubular members 3 has a hole 32 defined through the wall thereof and the resilient member 2 has two rings 21 on two ends thereof. Two fixing members 33 respectively extend through the two holes 32 of the two tubular members 3 and the two rings 21 of the resilient member 2 to connect the two ends of the two tubular members 3.

The two positioning units 4 are respectively formed to the two tubular members 3 respectively so as to position the tubular members 3 to the handle 1. The positioning unit 4 has an elongate guide slot 41 which is defined axially through the wall of the positioning unit 4, and a recess 42 is defined radially through the wall of the positioning unit 4 and communicating an end of the elongate slot 41. The recess 42 is located close to the steering post 6. An angle is defined between the elongate slot 41 and the recess 42 is less than 90 degrees. Two pins 43 are respectively connected to two ends of the handle 1 and engaged with the elongate guide slots 41. The pin 43 can be engaged with the recess 42 to position the tubular member 3 relative to the handle 1. Two grasp tubes 5 are respectively mounted to the two tubular members 3.

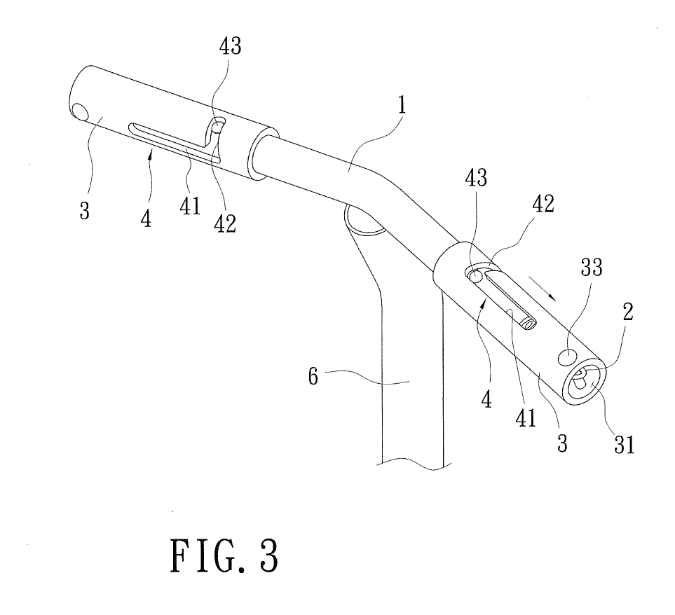

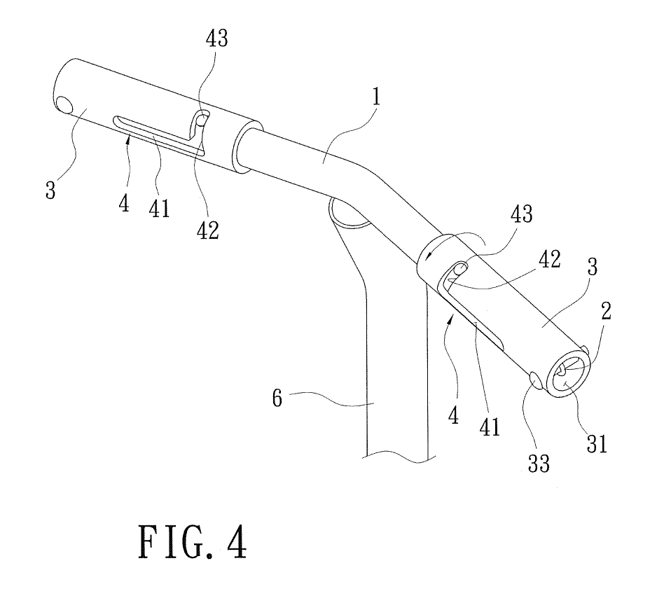

Further referring to FIGS. 3 and 4, when in use, the user holds the two grasp tubes 5 and the tubular members 3 and pull then away from the steering post 6, the resilient member 2 are extended in the two opposite directions. The pins 43 move along the guide slots 41 and are eventually engaged with the recesses 42 by rotating the tubular members 3 and the grasp tubes 5 an angle. The resilient members 2 are kept the extended status, and the tubular members 3 and the grasp tubes 5 are then positioned at the extended status. Therefore, the user can easily hold the grasp tubes 5 and control the mobility scooter. In other words, the length of the handle is increased and the user can easily operate the mobility scooter by the longer handle which saves effort when turning the mobility scooter.

When the mobility scooter is not in use, and the mobility scooter is to be stored, the user holds the tubular members 3 and the grasp tubes 5 and rotates them an angle in the reverse direction, the pins 43 is removed from the recesses 42 and the resilient member 2 pulls the tubular members 3 back. The pins 43 move along the guide slots 41 and the tubular members 3 are simultaneously moved toward the steering post 6. Therefore, the tubular members 3 and the grasp tubes 5 move back to their retracted status. The shorter handle does not protrude beyond the two sides of the scooter.

The tubular members 3 are easily extended by pulling them away from the steering post 6 and the tubular members 3 are easily positioned by rotating an angle to allow the pins 43 to be engaged with the recesses 42. The longer handle allows the user to easily operate the scooter.

The tubular members 3 are moved back to their retracted status by rotating the tubular members 3 in reverse direction. The retracted tubular members 3 do not protrude beyond the two sides of the scooter and this is benefit for storage of the scooter.

While we have shown and described the embodiment in accordance with the present invention, it should be clear to those skilled in the art that further embodiments may be made without departing from the scope of the present invention.

What is claimed is:

1. A retractable handle comprising:
a handle;
at least one tubular member mounted to the handle, a resilient member located between the handle and the at least one tubular member, and
a positioning unit connected to the handle and the tubular member so as to position the tubular members to the handle.

2. The retractable handle as claimed in claim 1, wherein the handle is a hollow tube and has a first space defined therein, the resilient member is located in the space and a second space of the at least one tubular member.

3. The retractable handle as claimed in claim 2, wherein the positioning unit has an elongate guide slot which is defined axially through a wall of the positioning unit, a recess is defined radially through the wall of the positioning unit and communicating an end of the elongate slot, two pins are respectively connected to two ends of the handle and engaged with the elongate guide slots, and the pin can be engaged with the recess to position the tubular member relative to the handle.

4. The retractable handle as claimed in claim 3, wherein an angle is defined between the elongate slot and the recess is less than 90 degrees.

5. The retractable handle as claimed in claim 1, wherein the positioning unit has an elongate guide slot which is defined axially through a wall of the positioning unit, a recess is defined radially through the wall of the positioning unit and communicating an end of the elongate slot, two pins are respectively connected to two ends of the handle and engaged with the elongate guide slots, and the pin can be engaged with the recess to position the tubular member relative to the handle.

6. The retractable handle as claimed in claim 5, wherein an angle is defined between the elongate slot and the recess is less than 90 degrees.

7. The retractable handle as claimed in claim 1, wherein the resilient member is one of a spring, a rubber band and a compound resilient member.

8. The retractable handle as claimed in claim 1, wherein a grasp tube is mounted to the at least one tubular member.
